(19) United States
(12) Patent Application Publication
(10) Pub. No.: US 2011/0140382 A1
(43) Pub. Date: Jun. 16, 2011

(54) DEER HITCHER

(76) Inventor: Steven SCHEERMESSER, Keyser, WV (US)

(21) Appl. No.: 12/711,723

(22) Filed: Feb. 24, 2010

Related U.S. Application Data
(60) Provisional application No. 61/209,606, filed on Mar. 9, 2009.

(51) Int. Cl. B62B 1/20; B62B 1/18

(52) U.S. Cl. 280/47.131

(57) ABSTRACT

An carrier apparatus for hauling is load is provided. The carrier includes a platform having a first body segment pivotally attached to a second body segment at a pivot point, each of the first body segment defines a first generally planar support area and the second body segment defines a second generally planar support area. The platform is configured to be arranged in a hauling mode, a hitch mode and a storage mode, by reconfiguration the first body segment with respect to the second body segment.

### CROSS-REFERENCE TO RELATED APPLICATIONS

This application claims priority from U.S. Provisional Patent Application No. 61/209,606 filed on Mar. 9, 2009 in the U.S. Patent Trademark Office, the disclosure of which is incorporated herein in its entirety by reference.

### BACKGROUND OF THE INVENTION

1. Field of the Invention

Apparatuses and methods consistent with the present invention relate to a convertible hauling device, and in particular, a game hauling device for hauling game in rugged terrain in a first mode and for hauling game via a hitch attachment in a second mode.

2. Description of the Related Art

The present invention involves a convertible apparatus that enables a person to transport a load over rugged terrain.

One such apparatus in the related art, such as the collapsible game hauling carrier discloses in U.S. Pat. No. 6,283,496, is configured to be collapsible for storage. However, this collapsible carrier exhibits a high center of gravity compared with the wheel base when loaded. Similarly, the collapsible cart disclosed in U.S. Pat. No. 7,172,207 exhibits similar drawbacks. Consequently, these carriers are susceptible to instability when used in rugged terrain including rocks and logs. Moreover, these carriers are only capable of transporting loads under human power.

U.S. Pat. No. 5,810,374 discloses a game carrier that shows a lower center of gravity than the related art described above. However, this game carrier has wheels centered along a long horizontal load carrying bed. Accordingly, it is difficult to maneuver this carrier over rocks and logs because due to its lowered base, as one end is raised, the other end approaches the ground. This carrier does not provide adequate clearance and requires careful maneuvering over rugged terrain.

In retrospect, there is a need for a game carrier that has a low center of gravity, but which exhibits improved maneuverable over rugged terrain.

### SUMMARY OF THE INVENTION

Exemplary embodiments of the present invention address at least the above problems and/or disadvantages and other disadvantages not described above. Also, the present invention is not required to overcome the disadvantages described above, and an exemplary embodiment of the present invention may not overcome any of the problems described above.

It is an aspect of the present invention to provide a game hauling apparatus that is exhibits a low center of gravity and that is maneuverable over rugged terrain.

According to an exemplary aspect of the present invention, a carrier is provided that includes a platform having a first body segment pivotally attached to a second body segment at a pivot point, each of the first body segment defines a first generally planar support area and the second body segment defines a second generally planar support area; and a handle attached to one of the first body segment and the second body segment.

The plat form may be arranged in a hauling mode and a hitch mode, wherein in the hauling mode the first generally planar support area is configured to intersect the second generally planar support area at an angle less then 180 degrees at attachment positions of the first body segment and the second body segment and a wheel assembly is attached substantially adjacent a line running through the attachment positions, and wherein in the hitch mode the first generally planar support area is configured to intersect the second generally planar support area lie in substantially the same plane.

The carrier platform may also be configured to be arranged in a storage mode wherein the first body segment is folded over the second body segment around the pivot point.

When in the hauling mode the wheel assembly may be attached below the attachment positions of the first body segment and the second body segment. The first body segment and the second body segment each comprise two side rails joined by a plurality of cross rails.

The carrier may also include a fixing mechanism to fix the first body segment to the second body segment at the angle less than 180 degrees when in the hauling mode and a second fixing mechanism to fix the first body segment to the second body segment in the substantially same plane when in the hitch mode. The fixing mechanism may include at least one of a bolt or pin penetrating mating holes in the first body segment and the second body segment.

The carrier may include a hitch receiver tube disposed below the pivot point that is configured to be attached to a hitch of a vehicle.

Also to permit a more compact storage configuration the first body segment is wider in a direction parallel to pivot axis than the second body segment and longer than the second body segment in a direction perpendicular to the pivot axis. To enable compact storage for a handle, the first body segment is longer than the second body segment by at least a thickness of the handle.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a view of a carrier according to an exemplary embodiment'

FIG. 2 is a close up view of FIG. 1;

FIG. 3 is a view of the carrier in a hitch mode;

FIG. 4 is a close up view of FIG. 3;

FIG. 5 is a view of the carrier in a storage mode.

### DETAILED DESCRIPTION OF EXEMPLARY EMBODIMENTS

Certain exemplary embodiments of the present invention will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the present invention can be carried out without those specifically defined matters. Also, well-known functions or constructions are not described in detail since they would obscure the invention with unnecessary detail.

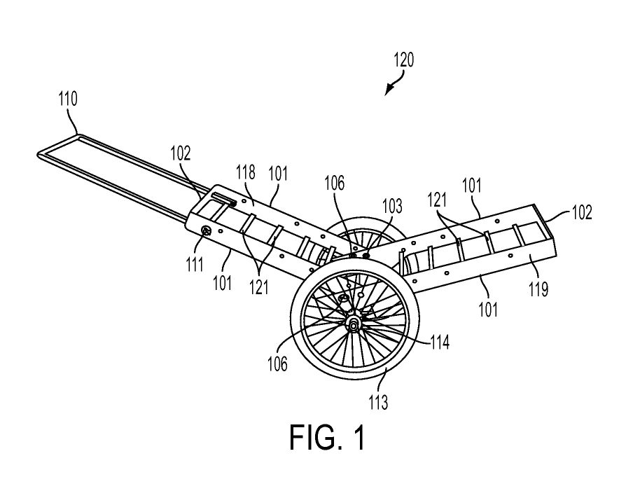

FIG. 1 shows an exemplary embodiment exhibiting several aspects of the present invention. As shown in FIG. 1, the carrier 120 is fitted with wheels 113 to permit a user to haul or move a load. In this application hauling means the moving of any desired item on the body of the carrier including, but not limited to, game, furniture, sporting goods or equipment, outdoor equipment, and any other item that needs to be moved. When used for hauling, wheels 113 are attached to a load carrying platform formed by connecting a first body segment 118 to a second body segment 119. The first body segment 118 is formed by side rails 101 attached to an end rail 102. A plurality of cross rails 121 are attached along the length of the side rails 101 to provide additional support for the load. The second body segment 119 is formed in a similar manner. The size of the crossbars and side rails can be varied depending on the material used, number of side rails and cross bars used, and item to be hauled.

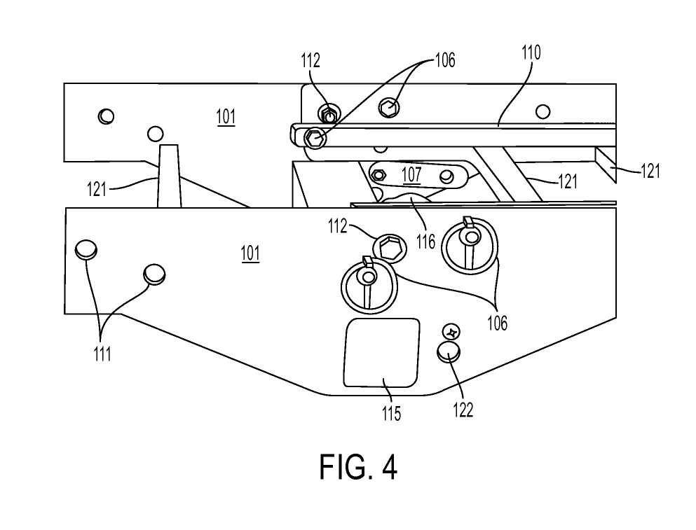

As shown in FIG. 1, the first body segment 118 and the second body segment 119 each form generally planar support structures that are connected to intersect at an angle ranging from 180 degrees to 0 degrees (folded over). By dropping this angular connection below 180 degrees, such as depicted in FIG. 1 (shows 135 degree angle), the configuration provides a clearance at the distal end portions of the body segments that exceeds the clearance height at the wheel 113 location. As a result, a shallow V-shaped carrying platform is formed. Further, to increase the clearance along the length of the carrier 120, the wheels are attached at a position corresponding to the point where the first body segment 118 and the second body segment 119 intersect, i.e., pivot point 104. While the wheel attachment may be centered, the wheel attachment need not be directly centered below the pivot point 104. However, the attachment may generally be positioned within 0 to 6 inches of a line projected vertically downward from the pivot point 104. As illustrated in FIG. 4, in an embodiment where a hitch receiver tube 115 is utilized, the wheels 113 may be attached at a distance from the vertically projected line and still be substantially centered within the whole of the platform body to maintain a good ground clearance.

Additionally, one or more set of wheels 113 may be mounted to the body of the carrier or detachably added by a fixing mechanism 114. The wheels may be any standard wheel including rubber, metal wheels or inflatable wheels if desired. In this embodiment, a detachable wheel assembly is used. The wheel is attached to the body using a removable axle that is fitted into holes through the carrier body. The wheels 113 can be held to the axles with nuts or pins or any other standard method of securing the wheels. The axle could also be permanently attached through the body of the carrier if so desired. In this embodiment, the platform is configured with holes 122 to receive an axle to support the wheels 113.

Also, the platform body of the carrier 120 is not limited to the structure described above. The platform body may be comprised of two or more pieces that can create a body and the dimensions of the body can be specifically catered to the size of preferred use depending on size of normal hauling items for a particular user. The body of the carrier may be comprised of any material sturdy enough for use such as steel, aluminum, a reinforced plastic, a metal composite, or any other material known to one skilled within the art.

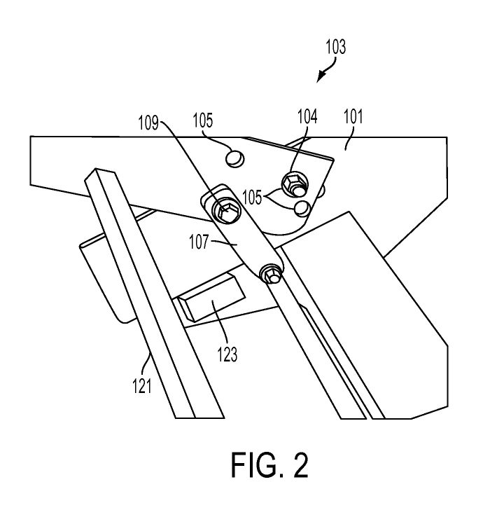

In the carrier embodiment comprised of two pieces, the first body segment 118 can be added to a second body segment 119 by the use of an attachment system such as a track system, a male/female system, a mirrored system in which the segments have holes that align which can also be male/female or track, or any other standard system known to one skilled in the art so that at least one end of the first body segment 118 can be attached to and end of the second body segment 119 at a point of attachment. The track system may utilize hinges 103 comprising a rotational attachment system in order to allow for rotation of the segments at the point of rotational attachment. As shown in FIG. 2, this embodiment utilizes a bolt to pivotally attach the first body segment 118 to the second body segment 119. In an embodiment utilizing more than two body pieces there can be a plurality of segments which can be attached in either static or rotatable fashion at multiple points of attachment depending on the use of hinges or a rotational attachment system in areas of desired rotational capabilities.

The rotational attachment system can be any attachment method that allows rotation of a mirrored attachment such as a bolt arrangement at the pivot point 104. A pivot bolt 112 can be added by mirrored holes 105 in the attached segments.

As set forth above, this embodiment allows for the user to place the segments at a desired angle with respect to the pivot point 104. Additionally a fixing mechanism can be used to keep the segments in place once the desired angle is reached. The fixing mechanism 106 can be any standard method of attaching the segments in static position such as the use of one or more rail pins with lynch pins, nuts, bolts, a pin with other retain methods such as cotter pins or any other method as would be understood by one skilled in the art. One or more rail pin holes 105 can be added to the segments in order to fix the segments at different angles. In addition to the pivot bolt 112 and fixing mechanism 106 one or more swing arms 107 may also be used. In a flat position the swing arm could be attached to a single segment 119 near the point of connection 108 for two segments. During the creation of an angle the swing arm can be attached to a hole 109 in the second body segment 118 to give added stability. The attachment to both can be made using bolts, pins or any other another method of attachment. Alternatively, the first segment may contain a permanent attachment while the second may utilize a reversible attachment method such as a rail pin. Additionally, one or more rail stops 123 may also be added to the end of any segment so that the carrier is prevented from extending beyond 180 degrees. The rail stop 123 can be any material of any size and can be attached to a first segment permanently or removably as long as it is capable of supporting a second segment from underneath so that segment cannot extend past horizontal when the segments are fixed together with the pivot bolt 112.

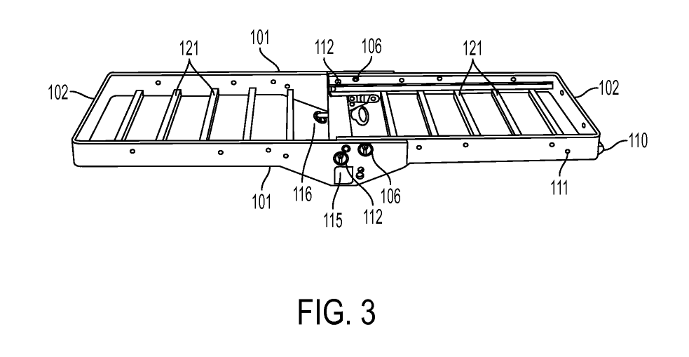

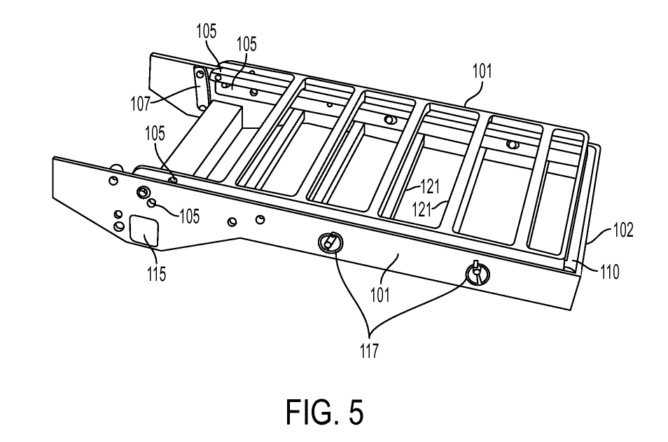

According to another aspect, the embodiment of FIGS. 1 and 2 may be configured for attachment to the hitch of a vehicle in a hitch mode (FIGS. 3 and 4), and to be folded for compact storage in a storage mode (FIG. 5). The ability of the carrier to be attached to a vehicle hitch allows a user to transport desired items outside a vehicle which can be especially important for the transport of certain items such as game. Of equal importance is the ability of the carrier to be condensed in size during storage or transport when not in use.

When in this hitch configuration, as shown in FIGS. 3 and 4, the first body segment 118 and the second body segment 119 are generally aligned at 180 degrees so that the supporting surfaces of the body segments lie in substantially the same plane. The carrier 120 includes a hitch receiver tube 115 to enable attachment to the hitch of a vehicle.

As shown in FIG. 3, this hitch receiver tube is generally positioned below the pivot point 4. The carrier may also be configured with multiple hitch receiver tubes added to the body 115. The hitch receiver tube 115 may be comprised of any material suitable for the rest of the body and may be a crossbar. The hitch receiver tube 115 may contain a hollow area of any size as long as it is capable of receiving the hitch of a vehicle on either or both side rail sides. The hitch receiver tube 115 may extend from one side rail to the other or only extend from a side rail far enough for a hitch to fit as a crossbar or can be separate. The hitch receiver tube 115 can also have a fixing mechanism such as a hitch pin 116 to fix the carrier to the vehicle. The hitch pin 116 can be added through a hitch pin hole in the hitch receiver tube 115. An axle may also be placed through an axle hole in the hitch receiver tube if the hitch receiver tube is a crossbar embodiment.

According to another aspect, the carrier 120 may include a handle 110. The handle may either be fixed, removable, or able to be pulled from one or both end bars when desired. A fixed handle may be added to one or both ends of the carrier. A removable handle can be added to either or both ends of the carrier by any standard fixing mechanism such as rail pins through one or more handle holes in the ends of the carrier and handle, a clasp, or any other fixing mechanism 111. A handle could also be stored within the body on tracks to be pulled from either or both ends and fixed when needed by any fixing mechanism such as rail pins through holes in the side rails and handles, a clasp, or any other fixing mechanism 112.

In the embodiment shown in FIGS. 1 and 3, the carrier is configured with two holes in the end rail 102 to slidably receive a corresponding side of the handle 110. FIG. 1 shows the handle extended for hauling and FIG. 3 shows the handle 110 retracted for use in the hitch mode. These figures also show how the handle is secured to the side rails when extracted and retracted by using bolts or pins, such as fixing mechanism 106 or fixing mechanism 111. Additionally, the handle could be stored in a manner where the grip end of the handle is attached to the end rail while two handle holes allow for the retraction and subtraction of the handle during either use or storage respectively with the handle being fixed during subtraction by a fixing mechanism. The handle may be made of the same material as the body or a different material and may include a gripping material such as rubber, raised rubber, or any other standard gripping material added.

The carrier may also be configured to be folding into a storage mode. According to an aspect of this mode, the carrier 120 may be configured such that the first body segment 118 folds over the second body segment 119 a shown in FIG. 5. The carrier may be secured in this position using fixing mechanisms 117.

To further reduce the size of the carrier 120 when in the storage mode, either the first body segment or the second body segment may be reduced in width to fit within the side rails of the wider body segment. This is illustrated in FIG. 5 where one body segment is folded over the other body segment to fit within the other body segment. Notably, in this configuration, the cross rails 121 exhibit a reduced height as compared to the side rails 101 to permit this overlap. Additionally, the inner body segment of FIG. 5 may also be configured with shorter side rails 101 to enable this overlap. Also, when a handle 110 is used, the inner body segment may be shorter than the outer body segment by at least the thickness of the handle 110 so that the handle can be compactly fitted within the outer body segment.

These terms and specifications, including the examples, serve to describe the invention by example and not to limit the invention. It is expected that others will perceive differences, which, while differing from the forgoing, do not depart from the scope of the invention herein described and claimed. In particular, any of the function elements described herein may be replaced by any other known element having an equivalent function.

Although a few exemplary embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A carrier comprising:
a platform having a first body segment attached to a second body segment;
a handle attached to one of the first body segment and the second body segment; and
a wheel assembly attached to the platform and configured to support the platform,
wherein each of the first body segment defines a first generally planar support area and the second body defines a second generally planar support area, the first generally planar support area intersecting the second generally planar support area at an angle less then 180 degrees at attachment positions of the first body segment and the second body segment,
wherein the wheel assembly is attached substantially adjacent a line running through the attachment positions.

2. The carrier according to claim 1, wherein the wheel assembly is attached below the attachment positions of the first body segment and the second body segment.

3. The carrier according to claim 1, wherein the first body segment and the second body segment each comprise two side rails joined by a plurality of cross rails.

4. The carrier according to claim 1, wherein the first body segment and the second body segment are pivotally attached.

5. The carrier according to claim 4, further comprising a fixing mechanism to fix the first body segment to the second body segment at the angle less than 180 degrees.

6. The carrier according to claim 5, wherein the fixing mechanism comprises at least one of a bolt or pin penetrating mating holes in the first body segment and the second body segment.

7. The carrier according to claim 1, where the wheel assembly is fixed to the platform using a shaft penetrating opposing sides of one of the second body segment and the first body segment.

8. A carrier comprising:
a platform having a first body segment pivotally attached to a second body segment at a pivot point, each of the first body segment defines a first generally planar support area and the second body segment defines a second generally planar support area; and
a handle attached to one of the first body segment and the second body segment,
wherein the platform is configured to be arranged in a hauling mode and a hitch mode,
wherein in the hauling mode the first generally planar support area is configured to intersect the second generally planar support area at an angle less then 180 degrees at attachment positions of the first body segment and the second body segment and a wheel assembly is attached substantially adjacent a line running through the attachment positions,
wherein in the hitch mode the first generally planar support area is configured to intersect the second generally planar support area lie in substantially the same plane.

9. The carrier according to claim 8, wherein the platform is also configured to be arranged in a storage mode wherein the first body segment is folded over the second body segment around the pivot point.

10. The carrier according to claim 8, wherein in the hauling mode the wheel assembly is attached below the attachment positions of the first body segment and the second body segment.

11. The carrier according to claim 9, wherein the first body segment and the second body segment each comprise two side rails joined by a plurality of cross rails.

12. The carrier according to claim 8, further comprising a fixing mechanism to fix the first body segment to the second body segment at the angle less than 180 degrees when in the hauling mode and a second fixing mechanism to fix the first body segment to the second body segment in the substantially same plane when in the hitch mode.

13. The carrier according to claim 12, wherein the fixing mechanism comprises at least one of a bolt or pin penetrating mating holes in the first body segment and the second body segment.

14. The carrier according to claim 8, further comprising a hitch receiver tube disposed below the pivot point that is configured to be attached to a hitch of a vehicle.

15. The carrier according to claim 9, wherein the first body segment is wider in a direction parallel to pivot axis than the second body segment and longer than the second body segment in a direction perpendicular to the pivot axis.

16. The carrier according to claim 15, wherein the handle is attached to the second body segment and the first body segment is longer than the second body segment by at least a thickness of the handle.

17. The carrier according to claim 11, wherein the pivot point is disposed above a center of a height of the side rails by at least a height of one of the plurality of cross rails.
